(19) United States
(12) Patent Application Publication
(10) Pub. No.: US 2009/0193176 A1
(43) Pub. Date: Jul. 30, 2009

(54) Data storage device having a built-in display

(75) Inventor: Shao-Ming Lee, Nan-Tou Hsien (TW)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Universal Scientific Industrial Co., LTD

(21) Appl. No.: 12/011,792

(22) Filed: Jan. 30, 2008

(51) Int. Cl. G06F 17/30; G06F 12/02

(52) U.S. Cl. 711/103; 707/3; 711/E12.008; 707/E17.014

(57) ABSTRACT

A data storage device for an electronic device includes a hard disk for storing a plurality of pieces of data, a nonvolatile memory for storing a plurality of file names corresponding to the pieces of data, a display, and a controller connected electrically to the hard disk, the nonvolatile memory and the display unit, and operable so as to permit viewing of the file names stored in the nonvolatile memory by displaying a viewing result including a viewed one of the file names on the display.

### BACKGROUND OF THE INVENTION

1. Field of the Invention

The invention relates to a data storage device, more particularly to a data storage device having a built-in display.

2. Description of the Related Art

FIG. 1 illustrates a conventional computer main module 1 that includes a housing 11, a hard disk 12 disposed in the housing 11, a main board 13 disposed in the housing 11 and mounted with a CPU 14 connected electrically to the hard disk 12, and a power supply 15 disposed in the housing 11 for supplying electric power to the conventional computer main module 1.

In such a configuration, only when the conventional computer main module 1 is activated, the hard disk 12 can be managed. Therefore, when the conventional computer main module 1 is deactivated or when the hard disk 12 is separated from the conventional computer main module 1, searching and viewing of data files stored in the hard disk 12 cannot be performed, thereby resulting in inconvenience during use.

### SUMMARY OF THE INVENTION

Therefore, the object of the present invention is to provide a data storage device that can achieve independent and improved data management with relatively low power consumption.

According to one aspect of the present invention, there is provided a data storage device for a computing apparatus. The data storage device comprises:

a data storage module for storing a plurality of pieces of data, and a plurality of file names corresponding to the pieces of data;

an input/output interface module adapted to be connected electrically to the computing apparatus for data and power transmission between the data storage device and the computing apparatus therethrough when the computing apparatus is activated;

a display;

a controller connected electrically to the data storage module, the input/output interface module and the display, and operable so as to search for the file names stored in the data storage module by displaying a search result including a searched one of the file names on the display; and

a power supply unit for supplying electric power to the data storage module, the display and the controller to enable the data storage device to conduct a search of the file names when the computing apparatus is deactivated.

According to another aspect of the present invention, there is provided a data storage device for an electronic device. The data storage device comprises:

a hard disk for storing a plurality of pieces of data;

a nonvolatile memory for storing a plurality of file names corresponding to the pieces of data;

a display; and

a controller connected electrically to the hard disk, the nonvolatile memory and the display unit, and operable so as to permit viewing of the file names stored in the nonvolatile memory by displaying a viewing result including a viewed one of the file names on the display.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional computer main module;

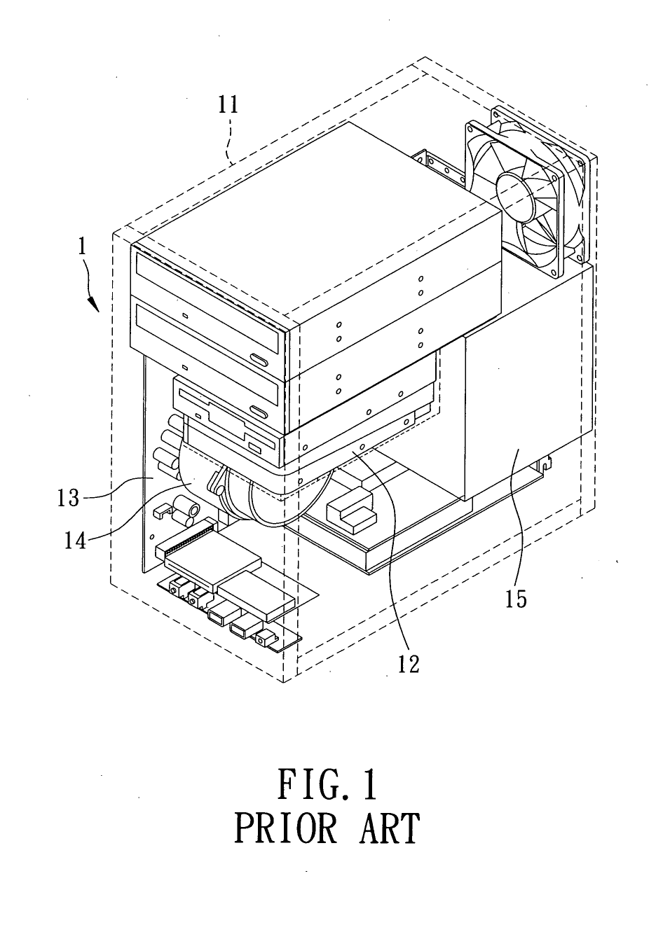

FIG. 2 is a perspective view showing the first preferred embodiment of a data storage device according to the present invention;

FIG. 3 is a schematic circuit block diagram illustrating the first preferred embodiment;

FIG. 4 is a bottom perspective view showing the first preferred embodiment with a bottom plate of a casing removed;

FIG. 5 is a perspective view showing the first preferred embodiment assembled to a computer main module; and

FIG. 6 is a schematic circuit block diagram illustrating the second preferred embodiment of a data storage device according to the present invention.

### DETAILED DESCRIPTION OF THE PREFERRED EMBODIMENTS

Before the present invention is described in greater detail, it should be noted that like elements are denoted by the same reference numerals throughout the disclosure.

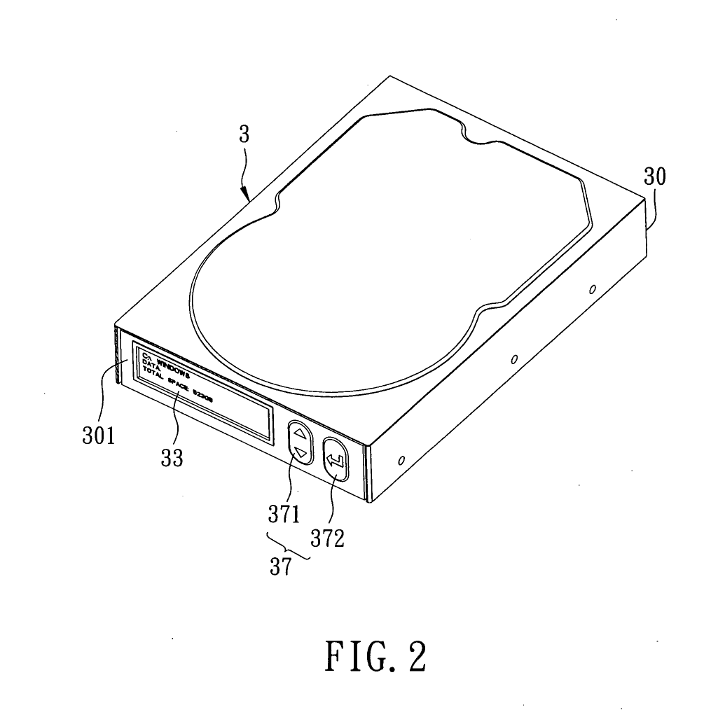

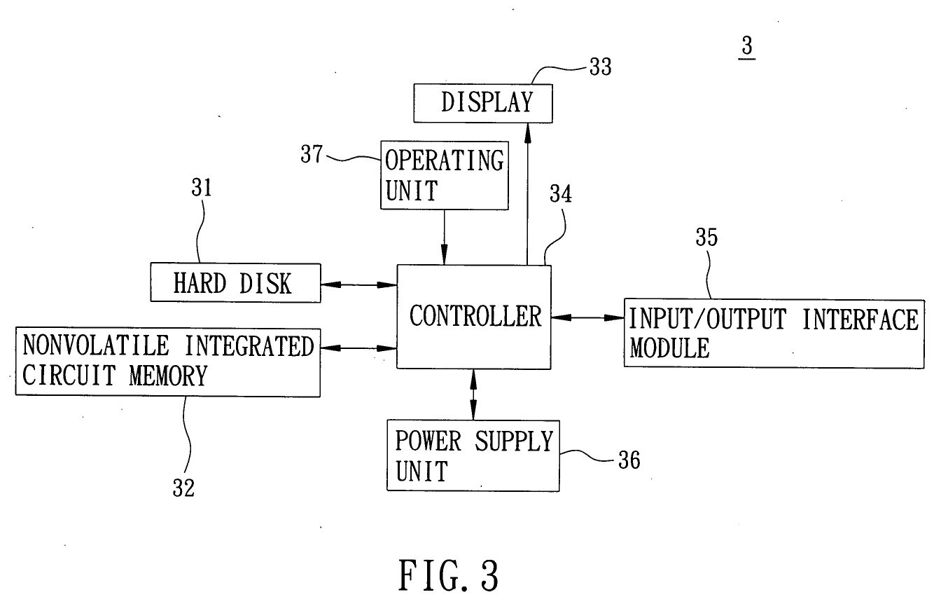

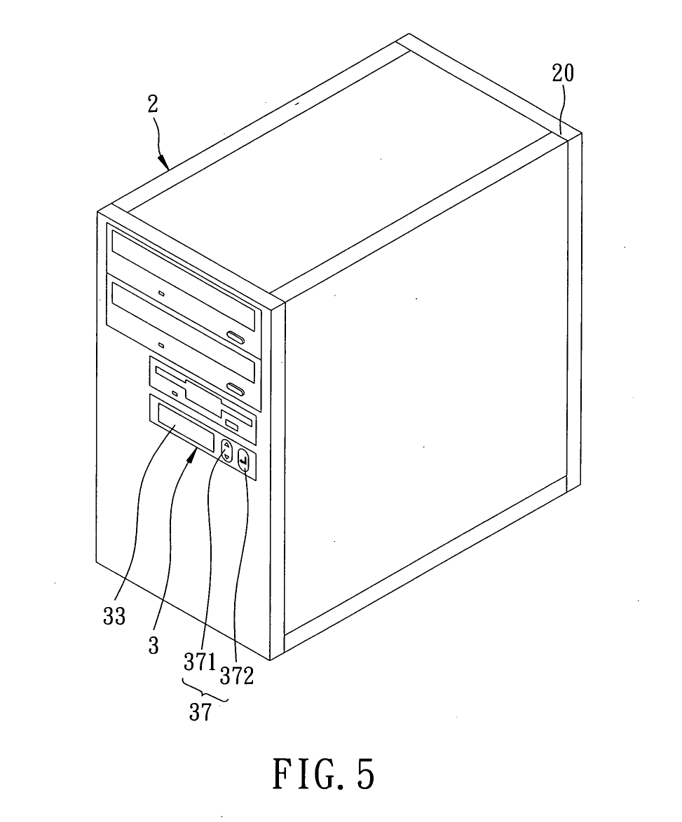

Referring to FIGS. 2 to 5, the first preferred embodiment of a data storage device 3 adapted for use with an electronic device, such as a computer main module 2, according to the present invention is shown to include a casing 30, a hard disk 31, a nonvolatile memory 32, a display 33, a controller 34, an input/output interface module 35, a power supply unit 36, and an operating unit 37.

The casing 30 is adapted to be assembled to and is separate from a housing 20 of the computer main module 2.

The hard disk 31 is disposed in the casing 30, and stores a plurality of pieces of data that are divided into at least one data cluster.

The nonvolatile memory 32 is disposed in the casing 30, is mounted on a circuit board 38, and stores a plurality of file names corresponding to the pieces of data. In this embodiment, the nonvolatile memory 32 is a flash RAM, and is configured with at least one directory corresponding to the data cluster therein and under which the file names are stored.

The display 33 is mounted on a front plate 301 of the casing 30.

The controller 34 is disposed in the casing 30, is mounted on the circuit board 38, and is connected electrically to the hard disk 31, the nonvolatile memory 32 and the display 33. The controller 34 is operable so as to permit viewing of the file names stored in the nonvolatile memory 32 by displaying a viewing result on the display 33. The viewing result includes a viewed one of the file names, and the directory storing the viewed one of the file names.

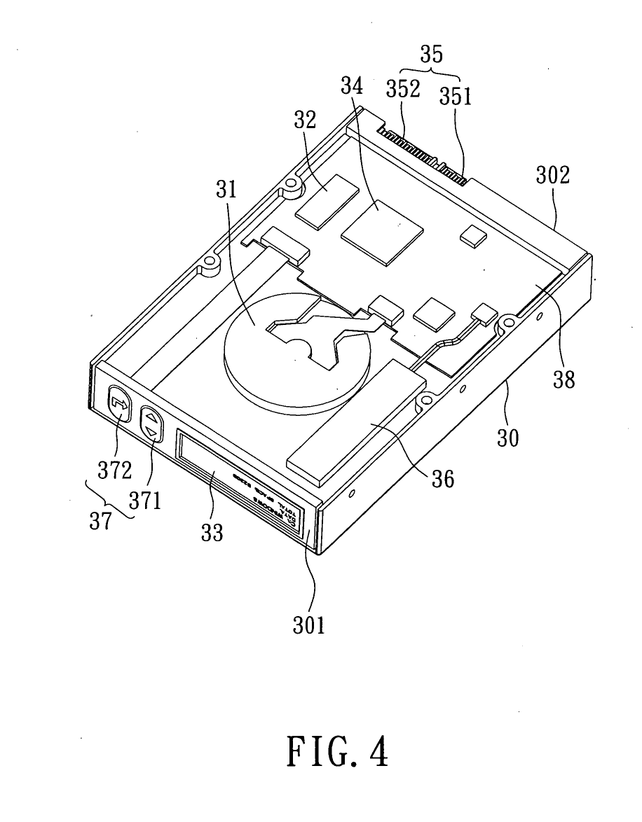

The input/output interface module 35 is mounted on a rear plate 302 of the casing 30, is connected electrically to the controller 34, and is adapted to be connected electrically to the computer main module 2 for data and power transmission between the data storage device 3 and the computer main module 2 when the computer main module 2 is activated. In this embodiment, as shown in FIG. 4, the input/output interface module 35 includes a first interface 351 for data transmission between the data storage device 3 and the computer main module 2, and a second interface 352 for power transmission from the computer main module 2 to the data storage device 3. When the computer main module 2 is activated, electric power from the computer main module 2 through the input/output interface module 35 is supplied to the hard disk 31, the nonvolatile memory 32, the controller 34 and the display 33 such that the controller 34 is operable to perform data access for the hard disk 31 through the input/output interface module 35 and directory setup for the hard disk 31. It is noted that the controller 34 is further operable to simultaneously update the file names stored in the nonvolatile memory 32 and the directory storing the file names upon changes in the pieces of data stored in the hard disk 31, and the data cluster.

The power supply unit 36 is disposed in the casing 30 for supplying electric power to the nonvolatile memory 32, the display 33 and the controller 34 to enable the data storage device 3 to permit viewing of the file names when the computer main module 2 is deactivated or when the data storage device 3 is separated from the computer main module 2. In this embodiment, the power supply unit 36 includes a rechargeable battery that is adapted to be charged by electric power from the computer main module 2 through the input/output interface module 35 when the computer main module 2 is activated.

The operating unit 37 includes a plurality of control keys 371, 372, is mounted on the front plate 301 of the casing 30, and is connected electrically to the controller 34. The operating unit 37 is operable so as to output a control signal to the controller 34 such that the controller 34 permits the viewing of the file names in response to the control signal from the operating unit 37.

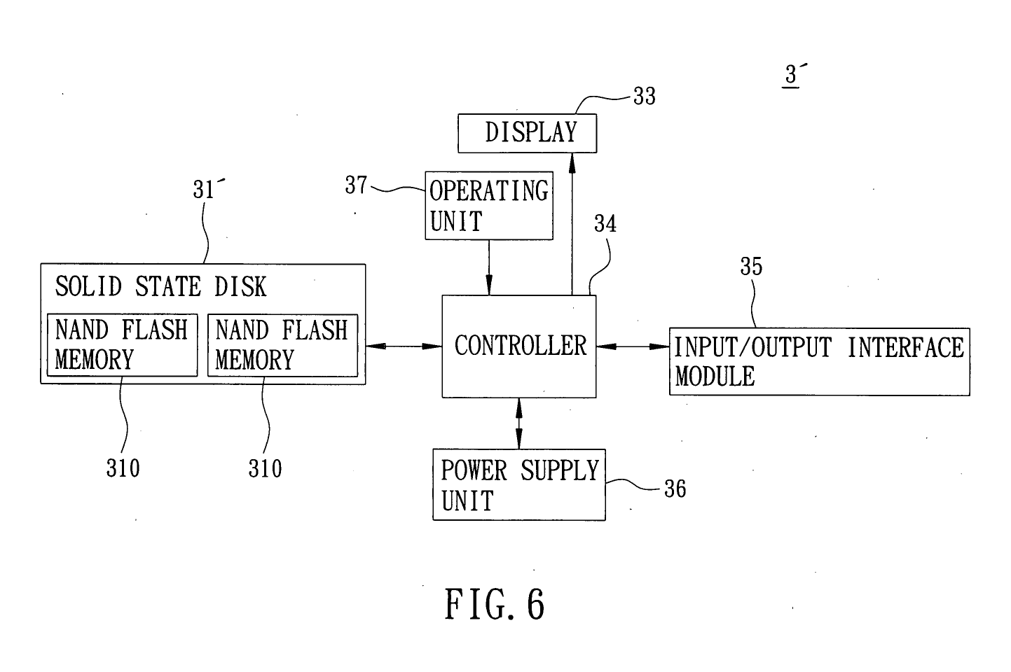

FIG. 6 illustrates the second preferred embodiment of a data storage device 3′ for a computing apparatus (not shown), such as a computer main module, according to this invention, which is a modification of the first preferred embodiment. In this embodiment, a data storage module is used as a substitute for the hard disk 31 and the nonvolatile memory 32 of the first preferred embodiment.

The data storage module is a solid state disk 31′ that includes a plurality of NAND flash memories 310 that store the pieces of data and the file names. The pieces of data stored in the NAND flash memories 310 are divided into at least one data cluster. The NAND flash memories 310 are configured with at least one directory corresponding to the data cluster therein and under which the file names are stored.

The controller 34 is operable so as to search for the file names stored in the solid state disk 31′ by displaying a search result including a searched one of the file names on the display 33.

The power supply unit 36 supplies electric power to the solid state disk 31′, the display 33 and the controller 34 to enable the data storage device 3′ to conduct a search of the file names when the computing apparatus is deactivated.

The operating unit 37 is operable so as to output a control signal to the controller 34 such that the controller 34 performs the search in response to the control signal from the operating unit 37.

It is noted that the controller 34 is further operable to perform one of data copying, data deleting and data moving operations on the search result in response to user operation of the operating unit 37 using the electric power from the power supply unit 36 when the computing apparatus is deactivated.

In sum, due to the presence of the nonvolatile memory 32 and the solid state disk 31′, the display 33 and the power supply unit 36, the data storage device 3, 3′ of the present invention can achieve independent and improved data management with relatively low power consumption.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A data storage device for a computing apparatus, comprising:
a data storage module for storing a plurality of pieces of data, and a plurality of file names corresponding to the pieces of data;
an input/output interface module adapted to be connected electrically to the computing apparatus for data and power transmission between said data storage device and the computing apparatus therethrough when the computing apparatus is activated;
a display;
a controller connected electrically to said data storage module, said input/output interface module and said display, and operable so as to search for the file names stored in said data storage module by displaying a search result including a searched one of the file names on said display; and
a power supply unit for supplying electric power to said data storage module, said display and said controller to enable said data storage device to conduct a search of the file names when the computing apparatus is deactivated.

2. The data storage device as claimed in claim 1, wherein said data storage module includes a solid state disk having at least one NAND flash memory that stores the pieces of data and the file names.

3. The data storage device as claimed in claim 2, wherein the pieces of data stored in said NAND flash memory are divided into at least one data cluster, said NAND flash memory being configured with at least one directory corresponding to the data cluster therein and under which the file names are stored, the search result displayed on said display including the directory storing the searched one of the file names.

4. The data storage device as claimed in claim 1, further comprising a casing adapted to be assembled to and separate from a housing of the computing apparatus, said data storage module, said controller and said power supply unit being disposed in said casing, said display and said input/output interface module being mounted on said casing.

5. The data storage device as claimed in claim 4, further comprising an operating unit mounted on said casing, connected electrically to said controller, and operable so as to output a control signal to said controller such that said controller performs the search in response to the control signal from said operating unit.

6. The data storage device as claimed in claim 5, wherein said controller is further operable to perform one of data copying, data deleting and data moving operations on the search result in response to user operation of said operating unit.

7. The data storage device as claimed in claim 1, wherein said power supply unit includes a rechargeable battery that is adapted to be charged by electric power from the computing apparatus via said input/output interface module when the computing apparatus is activated.

8. A data storage device for an electronic device, comprising:
a hard disk for storing a plurality of pieces of data;
a nonvolatile memory for storing a plurality of file names corresponding to the pieces of data;
a display; and
a controller connected electrically to said hard disk, said nonvolatile memory and said display unit, and operable so as to permit viewing of the file names stored in said nonvolatile memory by displaying a viewing result including a viewed one of the file names on said display.

9. The data storage device as claimed in claim 8, wherein said nonvolatile memory includes a flash RAM.

10. The data storage deviceas claimed in claim 8, wherein the pieces of data stored in said hard disk are divided into at least one data cluster, said nonvolatile memory being configured with at least one directory corresponding to the data cluster therein and under which the file names are stored, the viewing result displayed on said display including the directory storing the viewed one of the file names.

11. The data storage device as claimed in claim 8, further comprising a casing adapted to be assembled to and separate from a housing of the electronic device, said hard disk, said nonvolatile memory, and said controller being disposed in said casing, said display being mounted on said casing.

12. The data storage device as claimed in claim 11, further comprising an input/output interface module mounted on said casing, connected electrically to said controller, and adapted to be connected electrically to the electronic device for data and power transmission between said data storage device and the electronic device therethrough when the electronic device is activated.

13. The data storage device as claimed in claim 12, further comprising a power supply unit disposed in said casing for supplying electric power to said nonvolatile memory, said display and said controller to enable said data storage device to permit viewing of the file names when the electronic device is deactivated.

14. The data storage device as claimed in claim 13, wherein said power supply unit includes a rechargeable battery that is adapted to be charged by electric power from the electronic device through said input/output interface module when the electronic device is activated.

15. The data storage device as claimed in claim 11, further comprising an operating unit mounted on said casing, connected electrically to said controller, and operable so as to output a control signal to said controller such that said controller permits the viewing of the file names in response to the control signal from said operating unit.
